(19) United States
(12) Patent Application Publication
(10) Pub. No.: US 2025/0368531 A1
(43) Pub. Date: Dec. 4, 2025

(54) MXENE BASED COMPOSITE AS ANODE FOR ELECTROCHEMICAL DEVICES, AND METHOD OF SYNTHESIZING THE SAME

(71) Applicant: COUNCIL OF SCIENTIFIC AND INDUSTRIAL RESEARCH, New Delhi (IN)

(72) Inventors: Manjusha Vilas SHELKE, Pune (IN); Meenakshi Dnyaneshwar PAWAR, Pune (IN); Thripuranthaka MARULASIDDAPPA, Pune (IN)

(21) Appl. No.: 19/228,347

(22) Filed: Jun. 4, 2025

(30) Foreign Application Priority Data
Jun. 4, 2024 (IN) 202411043452

(51) Int. Cl. C01G 33/00; B82Y 30/00

(52) U.S. Cl. CPC C01G 33/00; B82Y 30/00; C01P 2002/01; C01P 2002/72; C01P 2002/85; C01P 2002/90; C01P 2004/03; C01P 2004/04; C01P 2004/16; C01P 2006/12; C01P 2006/17; C01P 2006/40

(57) ABSTRACT

A MXene composite-based electrode for electrochemical devices is disclosed. Specifically, an electrochemical composite material comprising Ti₃C₂Tₓ-Nb₂Mo₃O₁₄ (MXene niobium molybdenum oxide, MXNMO) and a method of synthesizing the MXNMO composite is disclosed. An electrochemical energy storage device including the MXNMO composite as an electrode is also disclosed.

### CROSS-REFERENCE TO RELATED APPLICATIONS

The present application is based upon and claims the right of priority to IN Patent Application No. 202411043452, filed Jun. 4, 2024, the disclosure of which is hereby incorporated by reference herein in its entirety for all purposes.

### TECHNICAL FIELD OF THE INVENTION

The invention relates to MXene composite-based electrode for electrochemical devices. Specifically, the present invention relates to an electrochemical composite material including a new form of MXene and a method of synthesizing the electrochemical composite material. The present invention relates to electrochemical energy storage device comprising said composite material as electrode.

### BACKGROUND AND PRIOR ART OF THE INVENTION

Carbon foams are a form of porous carbons with monolithic structures and hierarchical pores. Many researchers have reported producing carbon foams from different carbon sources but using chemical-based synthetic foaming agents like polyvinyl alcohol, N-methyl pyrrolidone, etc. that suffer from mainly chemical hazards and hence the environmental concern. Advanced energy storage systems with higher energy and power density with long cycle life are required for the rapid growth of electric vehicles as well as large-scale grid energy storage. Supercapacitors (SCs) and lithium-ion batteries (LIBs) are two complementary electrochemical energy storage platforms that offer high power density with low energy density and high energy density with low power density, respectively. For combining the advantages of both LIBs and SCs in one device, Li-ion capacitors (LICs) using battery-type anode and capacitive cathode are developed.

The capacitor-type electrode investigation mainly focuses on activated carbon (AC) for its electrochemical double-layer capacitance. Because the adsorption-desorption process is much faster than the Li⁺ intercalation/de-intercalation reaction, the anode determines the energy features, while the cathode determines the power performance. AC is commonly used as the cathode, whereas battery type anodes like graphite, Li₄Ti₅O₁₂, and metal oxides are used in the anode side. LICs are designed to achieve high energy density without sacrificing power density. However, practical applications of LICs are drastically constrained by the kinetics imbalance between the capacitive cathode and the faradaic anode, resulting in poor rate capability and short cycling life.

MXenes have been proved to be promising electrode materials for electrochemical energy storage devices due to their layered structure, increased interlayer spacing, abundant surface functional groups, hydrophilic behaviour, and metallic conductivity. It has been demonstrated that pure MXenes as anodes for LIBs can provide stable specific capacities of about 70-225 mAh g⁻¹ within a 0-3 V vs. Li/Li⁺. However, surface functional groups attached to MXenes tend to be re-stacked and agglomerated. As a result, the electrode's active sites and e−/ion transfer pathways are noticeably diminished, which impairs the related electrochemical performance. Like other 2D materials, the re-stacking of MXene is a barrier to free ion accessibility.

A facile method for enhancing electrode's electrochemical performance involves combining MXene with other materials to prevent its restacking and enhance the inherent energy storage properties of composite. On the other hand, transition metal oxides (TMOs) show higher specific capacities, but most of them undergoes volume change during cycling, which impedes stability performance. The composite of MXene with TMOs can potentially resolve the individual issues of MXenes and TMOs by preventing restacking of MXenes due to TMOs and containing the volume change in TMOs due to buffering by MXenes. One of the TMOs, Niobium oxide (Nb₂O₅) is a battery type pseudocapacitive charge storage material with a fast Li ion diffusion route in conventional carbonate-based electrolytes and a stable potential range. It possesses a high theoretical Li-ion storage capacity of 200 mAh g⁻¹. However, its poor electrical conductivity obstructs the fast charge storage kinetics.

According to Kong et al. (ACS Nano 2015, 9, 11200-11208), pseudo capacitor with orthorhombic Nb₂O₅/graphene paper composite showed a high specific energy density of 47 Wh kg⁻¹ and power density of 18 kW kg⁻¹. Along with Nb₂O₅, 2D layered oxides such as MoO₃, V₂O₅, WO₃ etc. are also used as the intercalative type of electrode materials for LIBs. However, they suffer from poor electrochemical stability and low electrical conductivity.

To overcome the issues like poor electric conductivity and the high polarizability, mixed transition metal oxides like M-Nb—O (M=Ti[25], W[26], Mo[27], Na[28]) are synthesized, which exhibit better electrochemical performance than that of monovalent transition metal oxides because of the synergy developed between different metal cations. The layered-type transition metal oxides mentioned above can form polyanion, which results in a variety of novel structural arrangements like microporous, tunnel architectures, and open frameworks which are also appealing for LIBs.

P Hei et al. (Ionics 2022, 28, 3197-3205) synthesized carbon confined microspheres of Nb₂Mo₃O₁₄ for the application in LIB and achieved good cycling stability. The carbon confinement of Nb₂Mo₃O₁₄ results in faster Li ion diffusion and improved structural stability. Carbon coating and doping have been included to improve the conductivity. Though much research has been done to produce porous monolithic carbon foam from various carbon feedstocks using some chemical-based foaming agents, inventors find no reports on producing monolithic carbon foams from a low-value carbon feedstock and plant-based natural foaming agents.

Accordingly, the present invention discloses a composite of MXene having excellent rate performance and cycling stability. Further, the composite of MXene exhibit a robust crystalline framework and short electronic as well as ionic transport length, dramatically increasing its lithium storage properties.

### OBJECTS OF THE INVENTION

Accordingly, the main objective of the present disclosure is to provide an advanced energy storage systems with higher energy and power density with long cycle life.

An object of the present invention is to develop and fabricate high-performance anode materials with quick Li⁺ reaction kinetics.

An object of the present invention is to provide a composite material with combination of MXenes and TMOs

Another object of the present invention is to provide a method of synthesizing the composite material with combination of MXenes and TMOs.

Yet another object of the present invention is to provide electrochemical components produced using the composite material that includes the combination of MXenes and TMOs.

### SUMMARY OF THE INVENTION

Aspects of the present invention relates to a composite-based electrode for electrochemical devices. Specifically, the present invention relates to an electrochemical composite material including a new form of MXene and a method of synthesizing the electrochemical composite material. The present invention also relates to an electrochemical energy storage device comprising said composite material as an electrode.

In an aspect, the present invention provides a MXene based composite comprising: MXene material in combination with transition metal oxides, represented by the formula I as: TiₐC_{b}T_{c}-NbₓMo_{y}O_{z}; wherein a is 2-4, b is 1-3, x is 2-3, y is 2-4 and z is 11-17, wherein TiₐC_{b}T_{c} MXene (MX) is present as nanosheets in said composite, and NbₓMo_{y} O_{z}(NMO) is present as nanorods in said composite, wherein the T_{c} is a surface terminated functional group selected from —F, —O, and —OH, and wherein the NMO nanorods form an interfacial contact with the MXene nanosheets in said composite.

In an aspect, the present invention provides Ti₃C₂Tₓ-Nb₂Mo₃O₁₄ (MXene niobium molybdenum oxide, MXNMO) composite comprising: Ti₃C₂Tₓ MXene (MX) nanosheets and Nb₂Mo₃O₁₄ (NMO) nanorods, wherein the NMO nanorods form interfacial contact with the MXene nanosheets. In some embodiments, the MXene nanosheets are anchored on the surface of NMO nanorods through electrostatic interactions between negatively charged surface-terminated groups like —F, —OH, double bonded oxygen, and the positively charged Nb and Mo ions.

In an embodiment, the MXene nanosheets are anchored on the surface of NMO nanorods through electrostatic interactions between negatively charged surface-terminated groups like —F, —OH, double bonded oxygen, and the positively charged Nb and Mo ions.

In another embodiment, the composite comprises a structure having a Brunauer-Emmett-Teller (BET) surface area in the range of 30 to 40 m² g⁻¹.

In another embodiment, the composite comprises a Barrett-Joyner-Halenda Model (BJH) pore size distribution in the range of 2 to 10 nm.

In another embodiment, the amount of each metal or component present in MXNMO composite material is Ti: 15-20%; 0: 51-52%; C: 22-24%; Nb: 2-2.1%; and Mo: 3-3.1%. Preferably, Ti: 19.75%; O: 51.50%; C: 23.64%; Nb: 02.08%; and Mo: 03.03%.

In another aspect, the present invention provides a method of synthesizing the MXene based composite, comprising:
a. providing phase Ti₃AlC₂ MAX phase;
b. effecting selective extraction of Al from Ti₃AlC₂ MAX phase to obtain the nanosheets of Ti₃C₂Tx MXene;
c. synthesizing Nb₂Mo₃O₁₄ (NMO) from 1:3 mole ratio of the Nb₂O₅ and MoO₃ by a solid-state synthesis method;
d. mixing an aqueous solution of Ti₃C₂Tx MXene and NMO, followed by hydrothermal reaction under sealed conditions to obtain the MXNMO composite;
e. collecting and rinsing the MXNMO composite with water by vacuum filtration; and
f. drying the composite.

In another embodiment, the ratio of Ti₃C₂Tx MXene and NMO is 2:1 to 1:2; wherein the hydrothermal reaction is effected in an autoclave at 150° C. for 4 h; and wherein the drying is effected at 80° C. for 12 h

In another embodiment, the NMO synthesis comprising:
a. Mixing, grinding and drying the Nb₂O₅ and MoO₃ to obtain dried powder;
b. Ball milling the dried powder from step (a) to obtain fine powder;
c. Packing the fine powder in a quartz ampoule;
d. Heating the quartz ampoule containing the fine powder in a Nabertherm muffle furnace, followed by natural cooling to obtain NMO.

In another embodiment, the mole ratio of Nb₂O₅ and MoO₃ is 1:3 to 3:1; wherein the ball milling is effected at 240 rpm for 8 h; and wherein the heating is effected at 680° C. for 12 h at a 2° C. min-heating rate.

In another aspect, the present invention provides an electrochemical device comprising MXene based composite as a modified anode, wherein the anode material is coated with said composite material.

In another embodiment, the electrochemical device is Lithium-ion capacitors (LICs) selected from full cell device or half-cell device.

In another embodiment, the LIC full cell device comprises MXNMO anode, supercapacitor grade activated carbon (super AC) as a cathode in anode-to-cathode mass ratio of 1:4 and an organic electrolyte.

In another embodiment, the organic electrolyte is LiPF₆ in ethylene carbonate, diethyl carbonate and dimethyl carbonate in the ratio of 1:1:1 v/v/v.

In another embodiment, MXNMO anode exhibits a discharge capacity of 205 mAh g⁻¹ at 100 mA g after 100 cycles; and wherein the LIC full cell device exhibit specific capacitances of 17, 15, 12, 9.79, 8.2, 7, and 3 F g⁻¹ at current densities of 0.25, 0.5, 1, 1.5, 2, 2.5, and 5 A g⁻¹ respectively.

In another embodiment, LIC full cell device delivers energy density of 32.51 Wh kg¹ and a higher power density of 818.32 W kg⁻¹ and 85% capacitance retention over 4000 cycles at 0.5 A g⁻¹; and wherein the LIC full cell device delivers an energy density of 37.8 Wh kg⁻¹ (0.25 A g⁻¹) and a power density of 4244 W kg⁻¹ (5 A g⁻¹) and 85% capacitance retention over 4000 cycles at 0.5 A g⁻¹.

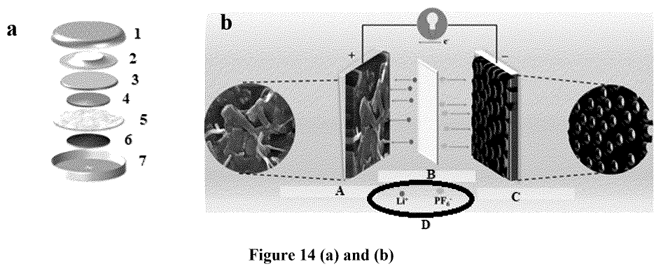

In yet another aspect, the present invention provides a LIC half-cell device (FIG. 14 a) comprising MXNMO anode (4), supercapacitor grade activated carbon (super AC) as a cathode (6) in anode-to-cathode mass ratio of 1:4, separator (5), positive case (7), negative case (1), spring (2) and a spacer (3) to separate the electrodes from the casing set-up.

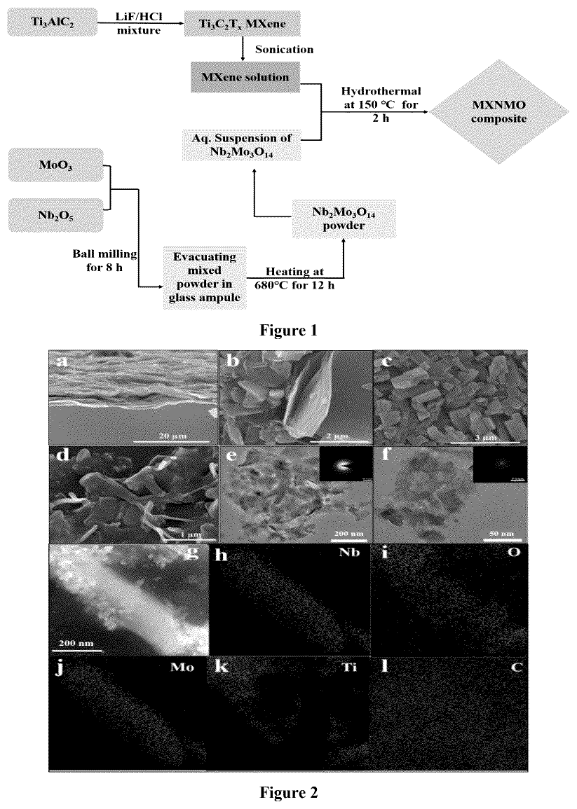

In yet another aspect, the present invention provides a LIC full cell device (FIG. 1b b) comprising MXNMO anode (A), supercapacitor grade activated carbon (super AC) as a cathode (C) in anode-to-cathode mass ratio of 1:4, separator (B) and an organic electrolyte (D).

### DETAILED DESCRIPTION OF THE DRAWINGS

FIG. 1: depicts the reaction scheme illustrating the synthesis of MXene nanosheets, NMO and the MXNMO composite.

FIG. 2: depicts the FESEM images of a) vertical cross-sectional MXene, b) top view of MXene, c) NMO, and d) MXNMO. e) TEM micrograph of MXene with corresponding SAED pattern as inset. f) HRTEM of MXNMO with inset of SAED pattern, g) elemental mapping of Nb, O, Mo, Ti, and C in the selected area of the composite.

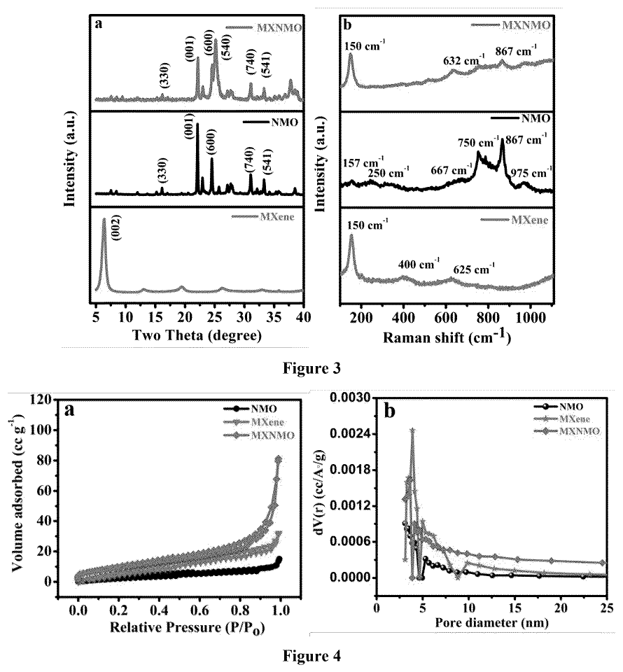

FIG. 3: depicts the a) Comparative XRD and b) Raman spectra of MXene, NMO and MXNMO composite.

FIG. 4: depicts the N₂ adsorption-desorption BET isotherms with corresponding BJH pore size distribution of MXene, NMO and MXNMO.

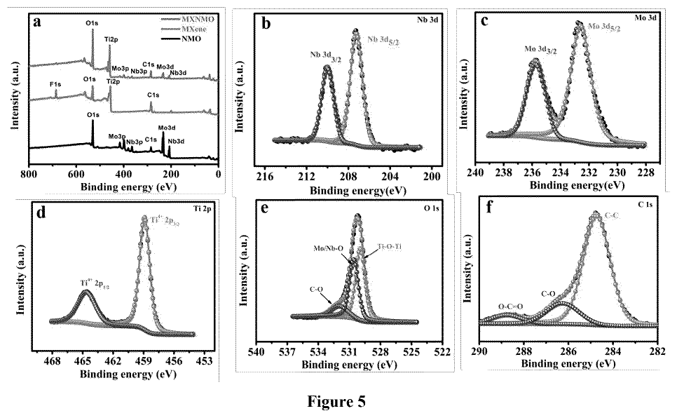

FIG. 5: depicts the a) XPS survey scan of MXene, NMO and MXNMO, High resolution deconvoluted peak spectra of b) Nb3d c) Mo3d d) Ti2p, e) O1s, and f) C1s of MXNMO composite.

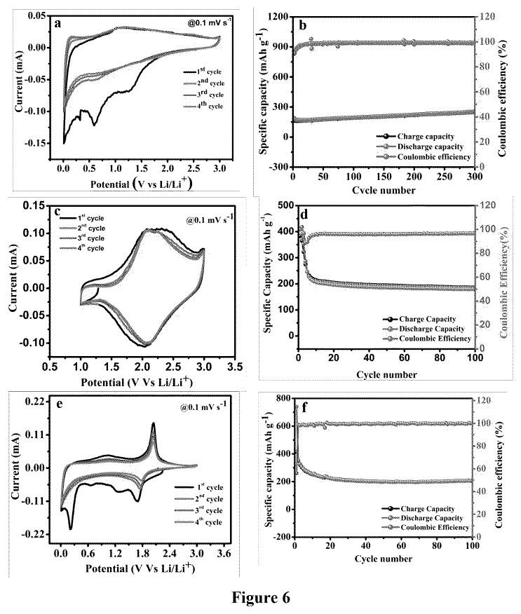

FIG. 6: depicts the electrochemical performance of all samples in Li half-cell; a, b) CV and stability plot of MXene; c, d) CV and stability data of NMO; e, f) CV and stability study of MXNMO composite at 0.1 A g⁻¹.

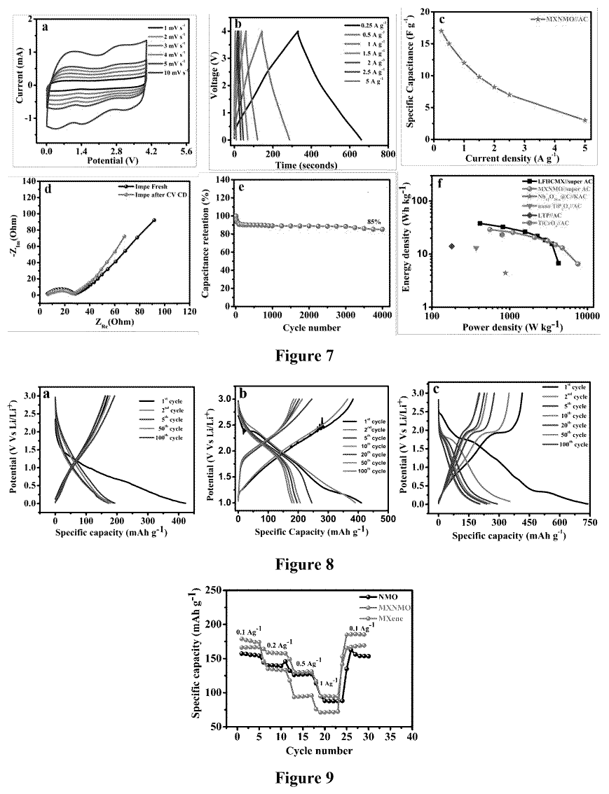

FIG. 7: depicts the Electrochemical performance of the full-cell MXNMO//super AC device. a) CV profile at various scan rates, b) GCD curves at different current densities, c) Rate performance d) Nyquist plot of full-cell before and after testing e) Cyclability data f) Comparative Ragone plot of the full-cell device with reported literatures at different current densities.

FIG. 8: depicts the GCD plots of different samples at 0.1 A g⁻¹: a) MXene, b) NMO, and c) MXNMO composite

FIG. 9: depicts comparative study of the MXene, NMO and MXNMO at different current rates.

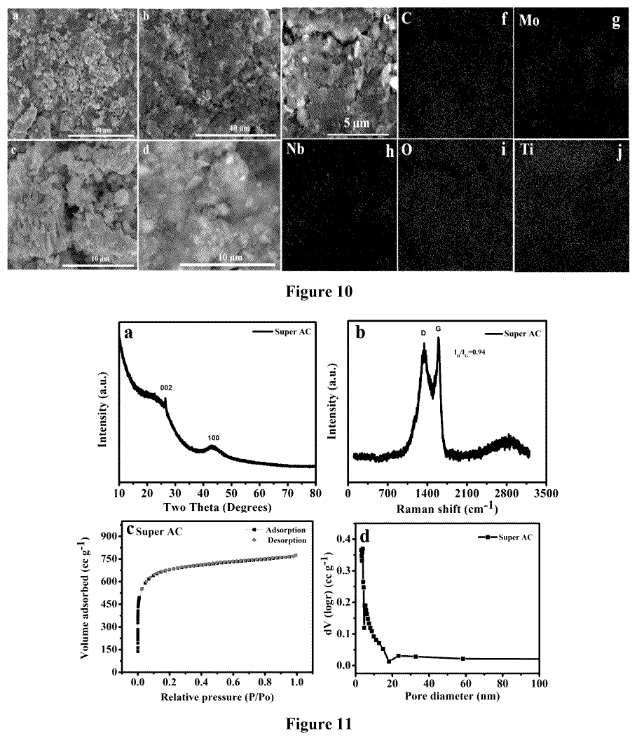

FIG. 10: depicts the Morphological study of MXNMO cycled electrode: a, c) FESEM images of bare MXNMO electrode; b, d) FESEM images of MXNMO composite after cycling; e-j) elemental mapping of C, Mo, Nb, O and Ti in the selected area of the cycled MXNMO composite.

FIG. 11: depicts the a) XRD pattern; b) Raman spectra; c) Adsorption desorption BET isotherm d) PSD of super AC.

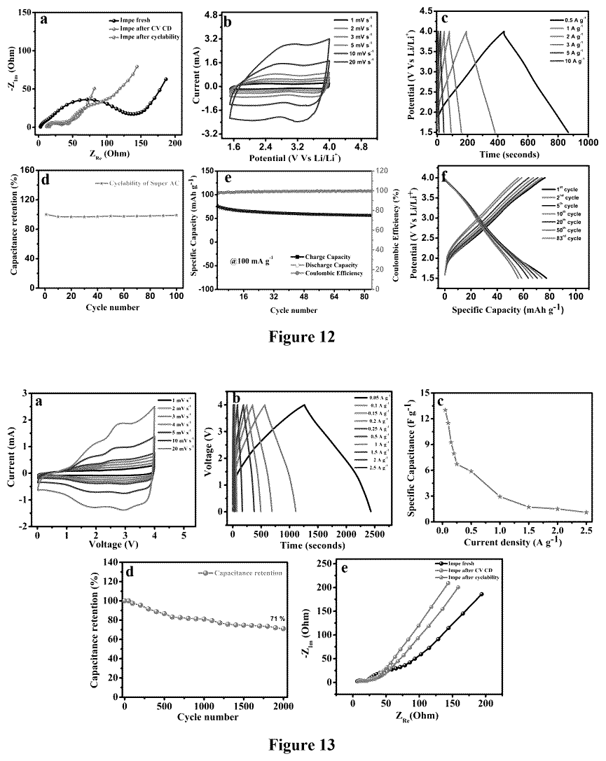

FIG. 12: depicts the a) Comparative EIS profile b) CV curves of super AC at different scan rates c) GCD curve at various current densities. d) Stability at 1 A g⁻¹ for 100 cycles. e) Cyclability f) GCD profile at 100 mA g⁻¹ of super AC.

FIG. 13: depicts the Full cell of MXene//AC LIC device: a) CV curve profiles at different scan rates b) GCD plot at different current densities in A g⁻¹ c) Rate performance study d) Capacitance retention at 1 A g⁻¹ for 2000 cycles e) Impedance study of full cell fresh and after testing.

FIGS. 14(a) and (b): depicts the Full cell of MXene//AC LIC device: a) Coin cell components used in Lithium-ion capacitor; and b) Representation of Hybrid Lithium-ion capacitor full cell setup

### SOURCE OF BIOLOGICAL MATERIAL

Not applicable

### Detailed Description of the Invention

Accordingly, embodiments of the present invention relates to a composite-based electrode for electrochemical devices. Specifically, the present invention relates to an electrochemical composite material including a new form of MXene and a method of synthesizing the electrochemical composite material. The present invention also relates to an electrochemical energy storage device comprising said composite material as an electrode.

In an embodiment of the present invention, the MXene supported mixed transition metal oxide (TMO) composites based upon Van der Waals interaction are highly efficient with self-assembly characteristics. The MXene nanosheets act as a conductive matrix for the quick electron/ion transport of NMO nanostructures in energy storage applications.

In an embodiment of the present invention, the MXene material in combination with transition metal oxides, represented by the formula I as: MXene material in combination with transition metal oxides, represented by the formula I as: TiₐC_{b}T_{c}-NbₓMo_{y}O_{z}, wherein a is 2-4, b is 1-3, x is 2-3, y is 2-4 and z is 11-17. In a preferred embodiment, the MXene is Ti₃C₂Tₓ and the TMO is Nb₂Mo₃O₁₄ (NMO). Here, T_{c} refers to the surface terminating functional group. Therefore, there will not be any value pertaining to “c”.

In an embodiment, the present invention provides Ti₃C₂Tₓ-Nb₂Mo₃O₁₄ (MXene niobium molybdenum oxide, MXNMO) composite comprising: Ti₃C₂Tₓ MXene (MX) nanosheets and Nb₂Mo₃O₁₄ (NMO) nanorods, wherein the NMO nanorods form interfacial contact with the MXene nanosheets. In some embodiments, the MXene nanosheets are anchored on the surface of NMO nanorods through electrostatic interactions between negatively charged surface-terminated groups like —F, —OH, double bonded oxygen, and the positively charged Nb and Mo ions.

In an embodiment of the present invention, the amount of each metal in MXNMO composite material is Ti: 15-20%; 0: 51-52%; C: 22-24%; Nb: 2-2.1%; and Mo: 3-3.1%. Preferably, Ti: 19.75%; O: 51.50%; C: 23.64%; Nb: 02.08%; and Mo: 03.03%.

In some embodiments, the MXene nanosheets retain the crystallinity and the hexagonal symmetry of the basal planes of the parent Ti₃AlC₂ phase, whereas NMO structure is made up of five MoO₆ octahedra and MoO₇ pentagonal bipyramids that share edges.

In an embodiment of present invention, NMO nanostructures form interfacial contact with MXene sheets and preserve the active sites of MXene, resulting in the improved electrochemical performance

In an embodiment, the MXNMO composite is employed in electrochemical devices. For example, electrodes and current collectors employ said composites, and those embodiments of these electrodes and current collectors are considered within the scope of this disclosure, as are electrochemical storage devices that comprise MXNMO composite and devices. Specific embodiments further consider the use of MXNMO composite and electrochemical devices in ion storage batteries, for example sodium or lithium ion storage batteries.

In an embodiment of the present invention, the MXNMO composite displays the structural characteristic wherein NMO nanorods are wrapped with MXene nanosheets.

In an embodiment of the present invention, the MXNMO composite exhibits a BET surface area of 30-40 m² g⁻¹. For example, 30 m² g⁻¹, 31 m² g⁻¹, 32 m² g⁻¹, 33 m² g⁻¹, 34 m² g⁻¹, 35 m² g⁻¹, 36 m² g⁻¹, 37 m² g⁻¹, 38 m² g⁻¹, 39 m² g⁻¹, or 40 m² g⁻¹. In some embodiments, the high specific surface area indicates that the addition of LiF/HCl avoids Ti₃C₂Tₓ layers stacking beneficial to provide an effective ion-contactable active sites.

In an embodiment of the present invention, the MXNMO composite exhibits a BJH pore size distribution of 1-100 nm. For example, 1, 2, 3, 4, 5, 6, 7, 8, 9, 10, 11, 12, 13, 14, 15, 20, 25, 30, 35, 40, 45, 50, 55, 60, 65, 70, 75, 80, 85, 90, 95, or 100 nm. Preferably 1-10 nm. In some embodiments, the enhanced porous structure of MXNMO is favorable to provide more active sites to accommodate electrolyte ions and diffusion path.

In an embodiment of the present invention, the MXNMO composite has a total amount of porosity of at least 5%, 10%, 15%, 20%, 25%, 30%, 35%, 40%, 45%, 50%, 55% or higher based on the total volume. In many cases, the total porosity is within the range of from 5 to 10%; from 10 to 15%; from 15 to 20%; from 20 to 25%; from 25 to 30%; from 30 to 35%; from 35 to 40%; from 40 to 40%; from 40 to 45%; from 45 to 50%; from 50 to 55% based on the total volume. In some embodiments, the total porosity can be 30 to 45% or from 35 to 50% based on the total volume. Higher or lower levels of total porosity also can be obtained.

In an embodiment, present invention provides method of synthesizing MXNMO composite comprising:
a. providing phase Ti₃AlC₂ MAX phase;
b. effecting selective extraction of Al from Ti₃AlC₂ MAX phase to obtain the nanosheets of Ti₃C₂Tx MXene;
c. synthesizing Nb₂Mo₃O₁₄ (NMO) from 1:3 mole ratio of the Nb₂O₅ and MoO₃ by a solid-state synthesis method;
d. mixing an aqueous solution of Ti₃C₂Tx MXene and NMO, followed by hydrothermal reaction under sealed conditions to obtain the MXNMO composite;
e. collecting and rinsing the MXNMO composite with water by vacuum filtration; and
f. drying the MXNMO composite.

In an embodiment of the present invention, the ratio of Ti₃C₂Tx MXene and NMO is 2:1 to 1:2. Preferably in the ratio of 1:1.

In an embodiment of the present invention, the hydrothermal reaction is effected in an autoclave at 100-200° C. for 1-6 hrs. Preferably, 150° C. for 4 hrs.

In an embodiment of the present invention, the drying is effected at 50-100° C. for 6-18 h. Preferably, the drying is effected at 80° C. for 12 h.

In another embodiment, the present invention provides a method of NMO synthesis comprising:
a. Mixing, grinding and drying the Nb₂O₅ and MoO₃ to obtain dried powder,
b. Ball milling the dried powder from step (a) to obtain fine powder,
c. Packing the fine powder in a quartz ampoule;
d. Heating the quartz ampoule containing the fine powder in a Nabertherm muffle furnace, followed by natural cooling to obtain NMO.

In an embodiment of the present invention, the mole ratio of Nb₂O₅ and MoO₃ is 1:3 to 3:1. Preferably, the mole ratio of the Nb₂O₅ and MoO₃ is 1:3.

In an embodiment of the present invention, the ball milling is effected at 100-500 rpm. For example, 100 rpm, 150 rpm, 200 rpm, 250 rpm, 300 rpm, 350 rpm, 400 rpm, 450 rpm, or 500 rpm. Preferably 240 rpm for 8 hrs.

In an embodiment of the present invention, the heating is effected at 680° C. for 12 h at a 2° C. min⁻¹ heating rate.

In yet another embodiment, present invention provides electrochemical device comprising MXNMO composite as a modified anode, wherein the anode material is coated with MXNMO composite.

In an embodiment of the present invention, the electrochemical device is Lithium-ion capacitor (LIC) selected from full cell device or half-cell device.

In yet another embodiment, the present invention provides a LIC half-cell device (FIG. 14 a) comprising MXNMO anode (4), supercapacitor grade activated carbon (super AC) as a cathode (6) in anode-to-cathode mass ratio of 1:4, separator (5), positive case (7), negative case (1), spring (2) and a spacer (3) to separate the electrodes from the casing set-up.

In yet another embodiment, the present invention provides a LIC full cell device (FIG. 14 b) comprising MXNMO anode (A), supercapacitor grade activated carbon (super AC) as a cathode (C) in anode-to-cathode mass ratio of 1:4, separator (B) and an organic electrolyte (D).

In an embodiment of present invention, separator material is but not limited to Whatman glass fibre.

In an embodiment of the present invention, the organic electrolyte (D) is LiPF₆ in ethylene carbonate, diethyl carbonate and dimethyl carbonate in the ratio of 1:1:1 v/v/v.

In an embodiment of the present invention, when used as electrodes, for example in lithium ion or sodium ion batteries or capacitors, the MXNMO composite of the present invention is capable of showing discharge capacities in a range characterized as of from 150 to 200 mAh g⁻¹, from 200 to 250 mAh g⁻¹, from 250 to 300 mAh g⁻¹, from 300 to 350 mAh g⁻¹, or any combination of two or more of these ranges when tested at 100 mA g⁻¹ after 100 cycles.

In an embodiment of the present invention, when used as electrodes, for example in lithium ion or sodium ion batteries or capacitors, the MXNMO composite of the present invention is capable of exhibiting a power density in a range characterized as of from 500 to 1000 W kg⁻¹, from 1000 to 2000 W kg⁻¹, from 2000 to 3000 W kg⁻¹, from 3000 to 4000 W kg⁻¹, from 4000 to 5000 W kg⁻¹ or any combination of two or more of these ranges when tested at 0.5 A g⁻¹ after 4000 cycles.

In an embodiment of the present invention, when used as electrodes, for example in lithium ion or sodium ion batteries or capacitors, the MXNMO composite of the present invention is capable of exhibiting a capacitance retention in a range characterized as of from 20 to 30%, from 30 to 40%, from 40 to 50%, from 50 to 60%, from 60 to 70%, from 70 to 80%, from 80 to 90%, or any combination of two or more of these ranges when tested at 0.5 A g⁻¹ after 4000 cycles.

In yet another embodiment, the present invention provides advanced cell electrodes and their assembly components, metal-ion battery electrodes, supercapacitors, EMI shielding, fabricated using the MXNMO composite as disclosed herein. In some embodiments, the MXNMO composite when used as electrode for any energy storage application it may work differently. When used in lithium or sodium ion batteries, it may exhibit a low power density than supercapacitors. In case of Lithium-ion capacitor, composite may exhibit the higher power density than that of electric double layer capacitor/supercapacitors. In addition, The composite will work efficiently for Metal ion batteries (MIB) because of multiple redox couples of Nb⁵⁺/Nb⁴⁺, Mo⁶⁺/Mo⁴⁺ from Niobium molybdenum oxide and good conductive network from MXene. This leads to the rapid transport network of ions and electrons throughout the electrode enabling reduced polarization in the electrode. The composite provides multidimensional metal ion diffusion system during charge discharge process of batteries.

In yet another embodiment of the present invention, the porous structure of MXNMO, compared to MXene, improves intercalating redox reactions through a large electrode/electrolyte interface area.

Also, MXNMO possesses a robust crystalline framework and short ionic/electronic transport, improving its lithium storage electrochemically. When used as anode for LICs, MXNMO exhibited better Li⁺ ion storage behaviour in terms of cycling stability and high-rate capacities than the MXene. Thus, unbalanced electrochemical kinetics of LIC device has been resolved by the pseudocapacitive MXNMO anode material with super AC as cathode. Thus, the hybrid Lithium-ion capacitor with cycling stability of MXNMO//super AC LIC full cell device for around 12000 cycles which exhibits 82% capacitance retention.

### EXAMPLES

Materials: Chemicals: Titanium Aluminium carbide (Ti₃AlC₂, particle size of 45 μm, >99%) was procured from Intelligent Materials Pvt. Ltd. Hydrochloric acid (HCl, 36.0-38.0%) and Lithium fluoride (LiF), Niobium oxide (99.99%), and Molybdenum oxide (99.5%) were purchased from Sigma Aldrich. N-methyl-2-Pyrrolidinone (NMP) and polyvinylidene fluoride (PVDF) were used from Sigma Aldrich for electrode slurry preparation. Super-p conducting carbon for slurry preparation and activated carbon for full cell were purchased from Global nanotech. The electrolyte used was 1 M LiPF₆ in ethylene carbonate, diethyl carbonate and dimethyl carbonate (EC/DEC/DMC, v/v/v=1:1:1). Whatman glass fiber as separator, and Li discs as counter and reference electrode were purchased from Global Nanotech.

Example 1:—MXene nanosheets Synthesis: The MXene nanosheets were prepared by exfoliating parent MAX phase Ti₃AlC₂. To the mixture solution 0.6 g of LiF in 10 mL of 9 M HCl solution, 0.5 g of Ti₃AlC₂ powder was added. The suspension in a sealed Teflon container was agitated at 40° C. with 300 rpm for 24 h. Then, the black solution was diluted and rinsed many times with deionized (DI) water till the solution pH becomes 6. For obtaining few layered dispersions the suspension was sonicated for 10 minutes and centrifuged at 3500 rpm to separate out the supernatant from unreacted MAX powder. Finally, the delaminated MXene named as MXene was obtained by washing the dispersed solution.

Example 2:—Synthesis of Nb₂Mo₃O₁₄ (NMO): The Nb₂Mo₃O₁₄ was synthesized by a solid state synthesis method. In a typical process, 1:3 mole ratio of the Nb₂O₅ and MoO₃ were mixed well by grinding in a mortar-pestle and dried for 8 h at 70° C. The dried powder was subjected to ball milling at 240 rpm for 8 h, and the obtained powder was then transferred into a quartz ampoule. The ampoule was evacuated thoroughly, sealed, and placed inside a Nabertherm muffle furnace and heated to 680° C. for 12 h at a 2° C. min⁻¹ heating rate. The tube was naturally allowed to cool down to room temperature, and the dark green colored powder samples of Nb₂Mo₃O₁₄ were collected.

Example 3:—Preparation of MXNMO composite: An aqueous solution of MXene and NMO (1:1 with 1 mg mL⁻¹ each) was ultrasonicated for 1 h and transferred to 50 mL autoclave. The autoclave with this solution was then kept for hydrothermal reaction at 150° C. for 4 h under sealed conditions. The autoclave was allowed to cool down at room temperature. The material was collected and rinsed with DI water by vacuum filtration. At last, product was dried at 80° C. for 12 h.

Example 4:—Material characterization: Surface morphology of the materials was determined by using Field Emission Scanning Electron Microscopy (FESEM) with NOVA NANO SEM 450 and High-resolution transmission electron microscopy (HRTEM) with JEOL JEM-200 electron microscopy. X-ray photoelectron spectroscopy (XPS) measurement was performed on a Thermofisher Scientific using a monochromatic Al K_{α} radiation source. The samples were dried at 100° C. in a vacuum oven for 1 h to remove the absorbed moisture before XPS analysis. Specific surface area (SSA) was determined by Brunauer Emmett-Teller (BET) using Nitrogen (N₂) adsorption/desorption isotherm, which was conducted on Quantachrome ASAP 2020. X-ray diffraction (XRD) analysis was conducted on Phillips PAN analytical diffractometer with Cu-K_{α} radiation (λ=1.54 Å). The Raman spectra were recorded on an HR 800 Raman spectrometer (Jobin-Yvon, Horiba, France) using a 532 nm red laser.

### Structural Characterization

FIG. 1a, b provides the schematic representation of the MXNMO composite preparation by coating MXene on the NMO nanorods. Firstly, the nanosheets of Ti₃C₂Tₓ MXene were efficiently prepared by the selective extraction of the Al from Ti₃AlC₂ MAX phase. NMO was prepared by the ball milling of finely grinded MoO₃ and Nb₂O₅ and then heated at 680° C. for 12 h at 2° min⁻¹ heating rate. Slow heating offers precursors enough time to react, restricting molybdenum from evaporating, especially at higher temperatures, and producing a single homogeneous desired product. The target compound breaks down into the niobium-rich MoNb₆O₁₈ phase and MoO₃ if the sample is heated above 700° C. Among Mo—Nb oxides, Nb₂Mo₃O₁₄ solid synthesized using a ceramic process, has the highest molybdenum content and uses the Mo₅O₁₄ structure. Even though both metals Nb and Mo are in their highest oxidation states, the produced product phase is stable in air and has an intense green colour. MXene and NMO nanoparticle precursors were self-assembled to obtain MXNMO hydrothermally mixing aqueous solutions of Ti₃C₂Tₓ and NMO. During this process, sheets of MXene were anchored on the surface of NMO nanorod through electrostatic interactions between negatively charged surface-terminated groups like —F, —OH, double bonded oxygen, and the positively charged Nb and Mo ions. NMO nanorods act as a substrate to avoid the aggregation and re-stacking of MXene nanosheets thereby preserving active sites from being lost.

In order to study the morphological and structural features of MXene, NMO, and composite, FESEM and HRTEM characterizations were performed. The vertical cross-sectional FESEM image of MXene film shows the formation of well aligned layered structure. (FIG. 2a) It indicates that the Al is etched out from Ti₃AlC₂, whereas a densely packed structure of the Ti₃AlC₂ observed with no interlayer spacing. After acid etching of Al from Ti₃AlC₂, MXene sheets are nicely exfoliated and FIG. 2c present the well crystalline rod-like morphology of NMO. MXNMO composite FESEM micrograph shown in FIG. 2d indicates that the nanorods are wrapped with MXene sheets. FIG. 2e shows the TEM micrographs of the MXene, showing the inset of the selected area electron diffraction (SAED) pattern of the corresponding TEM image. MXene nanosheets obtained by the solution method were terminated by fluorine, oxygen and hydroxide ion functional groups, which results in uniform coating of the nanosheet. The SAED pattern of the TEM image demonstrates that the MXene sheets retain the crystallinity and the hexagonal symmetry of the basal planes of the parent Ti₃AlC₂ phase. HRTEM image in FIG. 2f of the composite with inset of SAED pattern indicates a highly crystalline structure FIG. 2g-l shows the elemental mapping of MXNMO, indicating a homogeneous distribution of Mo, Nb, Ti, C and O. Nb:Mo weight ratio from energy-dispersive X-ray spectroscopy (EDX) analysis is 0.52, which is close to the ideal stoichiometric chemical composition.

The purity and phase of the prepared MXNMO composite was confirmed from XRD. FIG. 3a illustrates the comparative XRD patterns of all the samples. Both NMO and MXNMO show crystalline XRD pattern. NMO structure is made up of five MoO₆ octahedra and MoO₇ pentagonal bipyramids that share edges. The results are in good agreement with the tetragonal NMO phase, P 4/m b m (127) space group with lattice parameters a=b=23.16 Å and c=3.99 Å. MXNMO composite has a highly crystalline structure with intense peaks at 20 values 7.4°, 8.4°, 16.21°, 22.19°, 23.02°, 24.59°, 25.16°, 31.09°, 33.37° assigned to (200), (210), (330), (001), (600), (540), (630), (740) and (541) planes, respectively, according to JCPDS no. 18-0840 of NMO. The XRD pattern of the MXNMO exhibits peaks that are corresponding to NMO.

However, the (002) peak of the MXene could not be observed in the XRD pattern of MXNMO may be due to dominant scattering of X-rays from the NMO in the composite. According to JCPDS no. 052-0875 of MAX phase, the peaks showing the 20 values like 9.47°, 19°, 36.6°, 39.0°, 41.8° and 60.5° are assigned to the (002), (004), (103), (104), (105) and (110) planes of Ti₃AlC₂ MAX phase respectively. It can be seen that the two characteristic diffractions of Ti₃AlC₂ are detected around 9.47° and 39°. The inset of the XRD profile shows the (002) plane with the predominant broadening at the lower 2θ value for MXene. The (104) peak of Ti₃AlC₂ almost vanishes after LiF/HCl treatment, indicating that Al has been removed from Ti₃AlC₂, which provides strong evidence of the formation of Ti₃C₂Tₓ MXene. The broadened (002) peak also drifts from the 2θ angle of 9.47° (interlayer spacing 9.33 Å°) to 6.37° (interlayer spacing of 13.85 Å°) because of the structural expansion caused by a significant number of —F and —OH surface termination groups produced during LiF/HCl etching.

Comparative Raman spectra of all samples is shown in FIG. 3b. The Raman bands of NMO and MXNMO above 700 cm⁻¹ resemble typical Mo₅O₁₄ oxide structure. The band at 975 cm⁻¹ corresponds to M—O bond along the c-axis that MO₆ polyhedra share with one triangular channel. The M—O bonds in the ab-plane, where one-third of MO₆ polyhedra share two triangular channels and undergo strong distortion, are indicated by the bands seen at 750 cm⁻¹ and 867 cm⁻¹. Near about 900 cm⁻¹ small hump-like band is because of the terminal M—O bond stretching vibration, which is parallel to the c-axis of the MO₇ pentagonal bi-pyramidal columns. In the case of MXene the two peaks between 100 to 250 cm⁻¹ attributed to vanishing of Al—Ti vibrations (FIG. 3b) when compared with MAX, which confirms that Al has been etched out completely. In FIG. 3b, the peak at about 150 cm⁻¹ assigned to the vibration mode of Eg by the symmetric stretching vibration of O—Ti—O bond in the anatase phase, which may be due to the surface oxidation of the sample in the presence of atmospheric oxygen. The other peaks become broader and weaker compared to the MAX phase because of the enhanced interlayer spacing of MXene nanosheets.

The comparative N₂ adsorption-desorption isotherm and the corresponding pore size distribution curves of prepared samples are shown in FIG. 4a, b. The BET specific surface area of MXene, NMO and MXNMO composite was calculated to be 21, 9, and 36 m² g⁻¹, respectively. MXene exhibits typical type IV and type VI isotherms with stepped multi-layered construction. The high specific surface area indicates that the addition of LiF/HCl avoids Ti₃C₂Tₓ layers stacking beneficial to provide an effective ion-contactable active sites. NMO and MXNMO composite exhibits type VI curves with stepped construction and type II curves with H1 and H3 hysteresis loops, respectively. The composite shows an enhanced Specific surface area than that of MXene. The enhanced porous structure of MXNMO is favourable to provide more active sites to accommodate electrolyte ions and diffusion path. The BJH pore size distribution of all samples demonstrates that all samples have pores in the range of 2 to 10 nm.

To study the elemental composition of MXene, NMO and MXNMO, XPS measurement was performed. The XPS survey scan of the comparative samples is shown in FIG. 5a. In FIG. 5b, high-resolution spectra of Nb 3d in MXNMO composite exhibit peaks at 207.1 and 210.1 eV, which can be assigned to Nb 3d_{5/2} and Nb 3d_{3/2} binding energies (B.E.) of Nb⁵⁺, respectively. Mo 3d_{5/2} and Mo 3d_{3/2} B.E. of Mo⁶⁺ are mainly accountable for the XPS peaks in the Mo 3d spectra at 232.44 and 235.8 eV, respectively. (FIG. 5c) These XPS analyses confirmed that the Mo and Nb oxidation states are Mo⁶⁺ and Nb⁵⁺, respectively, in the MXNMO sample. Ti 2p_{3/2} (458.88 eV) and Ti 2p_{1/2} (464.93 eV), correspond to Ti⁴⁺ in MXNMO composite. (FIG. 5d) The three peaks of O 1s positioned at 529.8, 530.68 and 531.9 eV correspond to Ti—O—Ti, Mo/Nb—O bonds and C—O bonds respectively. (FIG. 5e) It can be observed that the C is spectrum has three prominent peaks at 284.74, 286.28, and 288.49 eV, which confirms carbon existence in MXNMO (FIG. 5f).

Example 5:—Electrochemical measurements: The half-cell study of MXene, NMO, and MXNMO as an anode was conducted in CR2032 coin cell assembly. The electrode slurry was made by using active material, PVDF binder, and Super P conducting carbon in 8:1:1 weight ratio with NMP used as a dispersant and coated on copper foil and subsequently vacuum dried at 100° C. for 12 h. The electrodes were prepared by cutting into a 14 mm diameter disc. The specific mass loading of the electrodes was 1.0-1.2 mg. Li foil was used as a counter electrode and 1 M LiPF₆ in EC/DEC/DMC, (volume ratio of 1:1:1) was used as electrolyte. The CR2032-type coin cells were assembled in Ar-filled glovebox with H₂O and O₂ content <0.1 ppm. Whatman glass fiber was used as the separator. The voltage window of the half-cells was 0.01 to 3.0 V. For the preparation of cathode electrodes, the slurry of Supercapacitor grade activated carbon (super AC), carbon black, and PVDF was mixed in a weight ratio of 8:1:1 in NMP which was then coated on carbon coated Al foil and dried at 100° C. in vacuum for 12 h. The working voltage window for the cathode was 1.5 V to 4.0 V. Before the fabrication of the LIC full-cell devices, MXNMO anode was prelithiated at 0.05 A g⁻¹ and discharged to 0.01 V. The anode-to-cathode mass ratio for the device was 1:4. The voltage window for LIC was 0.01 to 4.0 V. The calculation of the specific capacity (C, in mAh g⁻¹) of an electrode and specific capacitance (Csp, in F g⁻¹) of asymmetric supercapacitor devices were done using equation (1) and (2) respectively, while the Energy density (E, Wh kg⁻¹) and Power density (P, W kg⁻¹) of supercapacitor devices were calculated by using equation (3) and (4) as follows.

$$C = \frac{\text{?}}{3.6 \times m} \qquad ( 1 )$$

$${C}_{sp} = \frac{2 \text{?}}{M \text{?}} \qquad ( 2 )$$

$$E = \frac{1}{2} {C}_{sp} ( {V}_{f}^{2} - V \text{?} ) \qquad ( 3 )$$

$$P = \frac{\text{?}}{Δ c} \times 3600 \qquad ( 4 )$$

$$\text{?} \text{indicates text missing or illegible when filed}$$

where I is the input current, Δt is the discharge time and m is active mass loading of working electrode in half cell configuration as shown in equation (1). ∫Vdt is the integral area of discharge curve, and V is the potential with Vf and Vi are the final and initial values of asymmetric supercapacitor device and M is the total mass of anode and cathode active electrode materials in equation (2). The rate capability and cycling stability of half cells were estimated by MTI corporation battery analyzer. The electrochemical impedance spectroscopy (EIS), Cyclic voltammogram (CV), and galvanostatic charge-discharge (GCD) for LIC tests were performed using a Biologic VMP3 electrochemical analyser at ambient conditions. EIS was conducted from 500 kHz to 50 mHz with a 10-mV amplitude. The GCD of the half-cell was performed using an MTI battery analyzer.

The electrochemical performance of MXene, NMO and MXNMO composite was carried out in a half-cell configuration with lithium as a counter and/or reference electrode (FIG. 6). The CV curves of MXene at a potential window from 0.01 and 3 V with respect to reference electrode (V vs Li/Li⁺) at a scan rate of 0.1 mV s⁻¹ are shown in FIG. 6a. In the first cycle of MXene, three cathodic peaks were observed near 0.42, 0.63, and 1.2 V, which could be due to initial solid electrolyte interphase (SEI) formation and the irreversible reactions. The wide peaks at 0.6 and 1.1 V appear in the subsequent cycles, possibly due to the reaction of Li⁺ with Titanium-based MXene. Besides, the well-overlapped CV curves of MXene observed after the first cycle illustrate the high reversible electrochemical reactions. This is because of the Li⁺ ions reversible intercalation between the sheets of MXene in the working electrode. FIG. 8a and FIG. 6b show GCD curve and corresponding stability profiles of MXene for 300 cycles at a current density of 0.1 A g⁻¹. In the first discharge curve shown in FIG. 8a, the electrode exhibited an irreversible capacity of 421 mAh g⁻¹, amounting to the formation of the SEI layer. The charge-discharge voltage profiles of MXene at 0.1 A g⁻¹ are almost overlapped from the second to fifth cycles, reflecting with the CV curves by confirming the reversible Lithium-ion intercalation/deintercalation cycling stability. The stability data of MXene in FIG. 6b it was observed that during the cycling, the initial discharge capacity was 188 mAh g⁻¹ with C.E. of 90% which increased to 193 mAh g⁻¹ with the C.E. of 99% after 100 cycles and it goes upto 253 mAh g⁻¹ after 300 cycles with retained C.E. The consistent increase in capacity with increasing number of cycles is probably due to improved Li⁺ ion accessibility through electrolyte percolation into the electrode.

Utilizing a conventional nonaqueous electrolyte, we have examined the electrochemical study of NMO as a reversible Li⁺ ion storage material within the potential window of 1.0 V to 3.0 V vs. Li/Li⁺ (LiPF₆ in the solvent mixture). The cyclic voltammogram in FIG. 6c is displayed at a sweeping rate of 0.1 mV s⁻¹ for a potential range of 1.0 V to 3.0 V (V vs Li/Li⁺). The two distinct peaks at the cathodic and anodic scan correspond to the insertion of Li-ion into triangular and in channels of six and seven-membered structures to form LiₓNb₂Mo₃O₁₄ type solid solution. It is one such mixed metal oxide with open framework and its tunnel structure which can favour faster Li ion intercalation and deintercalation. It is important to note that because NMO is a three-dimensional structure with Niobium and Molybdenum which are randomly distributed throughout the crystal lattice, it can be challenging to determine the redox processes involved during charging and discharging. However, during the Li excursion into the framework structure, all metal ions actively participate. During this process, the metal ions are reduced during the Li-ion intercalation and oxidized during the reversible de-intercalation process. The cycling stability study (FIG. 6d) and the corresponding charge-discharge study (FIG. 8b) at 100 mA g⁻¹ could deliver the stable specific discharge capacity of 176 mAh g⁻¹ with 98.99% C.E. CV profiles of the MXNMO were measured in 0.01-3.00 V voltage range with respect to Li/Li⁺ as a reference electrode at a scan rate of 0.1 mV s⁻¹, which exhibited multiple redox peak pair, as depicted in FIG. 6e. A pair of sharp redox peaks at 1.72 and 1.90 V may be related to the redox reaction between Nb⁵⁺/Mo⁶⁺ and Nb⁴⁺/Mo⁴⁺. These peaks overlapped well from 2^{nd} cycle, indicating high reversibility of the redox couple. It implies that MXNMO has a small degree of polarization and great reaction kinetics. The peaks from 0.2 to 1.7 V in the first cycle assigned to decomposition of the electrolyte and SEI layer formation. The broad peak at 0.9 V in the anodic scan indicates Li-ion extraction from MXNMO. The charge-discharge and corresponding stability of the composite is given in FIG. 8c and FIG. 6f respectively. After irreversible capacity loss in the first cycle, the stable behaviour of the material can be seen in further stability data, which exhibits discharge capacity of 353, 253 and 210 mAh g⁻¹ after 2, 10 and 30 cycles respectively. With 100% C.E. The stable cycling behaviour of MXNMO was observed showing specific capacity of 205 mAh g⁻¹ at 0.1 mA g⁻¹ after 100 cycles with 100% C.E. In order to evaluate the recovered capacity and rapid Li⁺ ion transfer, all the samples were tested at different current densities such as 0.1, 0.2, 0.5, 1 and again revert back to 0.1 A g⁻¹ in comparative rate performance study shown in FIG. 9. MXene delivers reversible specific discharge capacity at around 166 mAh g⁻¹ at low current density of 0.1 A g 1, 101 mAh g⁻¹ at high current density (1 A g⁻¹) and when reverting back to the low current density of 0.1 A g⁻¹ it shows the reversible discharge capacity at around 168 mAh g⁻¹. In case of NMO, which shows average reversible capacities around 156, 138, 127, 83 and 153 mAh g⁻¹ at various current densities of 0.1, 0.2, 0.5, 1 and 0.1 A g⁻¹. MXNMO which yields excellent Li-storage capacity retention with an average discharge capacity of 175, 132, 94, 72 and 185 mAh g⁻¹ at various current rates of 0.1, 0.2, 0.5 and 1.0 and again towards 0.1 A g⁻¹. To understand the stability of MXNMO composite, the post-cycling FESEM characterization were performed after 100 cycles at 0.1 A g¹. FIG. 10a, 10c shows the FESEM images of bare electrode and FIG. 10b, 10d shows the FESEM images after cycling which depicts that the electrode has smoother surface with no cracks on it even after cycling for 100 times exhibiting robustness of the composite electrode. Further, FIG. 10(e-f) shows elemental mapping of the selected area in MXNMO composite electrode in which C, Mo, Nb, O and Ti are uniformly distributed after cyclability.

LIC full-cell performance: Based on the anode half-cell tests, the full-cell study of MXNMO composite was carried out. The MXNMO anode, which was prelithiated at 0.05 A g⁻¹ by discharging it up to 0.01 V, has been used with super AC cathode to make full-cell LIC capacitor device. The electrochemical performance of super AC was characterized and pretested at potential range between 1.5 and 4.0 V vs Li/Li⁺. It has a high surface area of 2223 m² g⁻¹ (FIG. 11) which is responsible for the high ion adsorption-desorption property as a cathode in an organic electrolyte based asymmetric supercapacitor. Super AC showed linear profiles and a 85 F g⁻¹ specific capacitance at 0.5 A g⁻¹ current density (FIG. 12). FIG. 7a display the CV profiles of MXNMO//super AC full-cell device at the sweep rate of 1 to 10 mV s⁻¹ between the working voltage window of 0.01 to 4 V. The CV graphs show a large charge storage area that gradually increases with increasing sweep rates (FIG. 7a). Because the specific capacity of the anode greatly outperforms that of the cathode, LIC was constructed by mass balancing of the cathode and anode with a mass ratio of 4:1. Nearly mirror image symmetric quasi rectangular CV shape at various scan rates, confirms well-matched reaction kinetics of the pseudocapacitive MXNMO and ion adsorption-desorption behaviour in super AC cathode. This leads to the presence of two distinct energy storage mechanisms in this device, namely the electric double layer at the cathode side and the Li⁺ ion insertion/extraction reaction at the anode side. It resembles similar shapes at different scan rates indicating a good electrochemical process. The triangular shape of the GCD plots at the current densities of 0.5 to 10 A g⁻¹ assures the remarkable capacitive behaviour of the hybrid full-cell device (FIG. 7b). The unique MXNMO//super AC cell achieves large specific capacitances of 17, 15, 12, 9.79, 8.2, 7, and 3 F g⁻¹ at current densities of 0.25, 0.5, 1, 1.5, 2, 2.5, and 5 A g⁻¹ respectively (FIG. 7c). An electrochemical impedance test conducted to understand the electrochemical kinetics of the assembled LIC device. EIS spectra of the device before and after CV and GCD cycles testing is shown in FIG. 7d. EIS spectra of device before cycling test was denoted as “Impe Fresh”. The EIS spectra of the device after consecutive CV and GCD cycle study was denoted as “Impe after CV CD”. Rₛ represents internal resistance and is related to the total resistance of the electrode, electrolyte, and the interface between electrolyte/electrode. R_{ct} represents charge transfer resistance representing the electrochemical process at the interface. Both Nyquist plots in high and low-frequency regions display a semicircle and slopping straight line, respectively. The device shows significant Rₛ and R_{ct} change after testing resulting in faster reaction kinetics. The R_{ct} value of fresh impedance shows 21.05Ω, and after CV, CD testing shows 21.34Ω. The Rₛ measured for fresh impedance and, after testing show 6.06Ω and 6.57Ω. After testing, the EIS result indicates that the full-cell device shows a slight increase in charge transfer resistance with slightly improved capacitive behaviour of full cell contributing the bulk property of intercalative MXNMO material. The cycling stability of MXNMO//super AC full-cell was performed at 1 A g⁻¹ shown in FIG. 7e. The capacitance retention of 92% and 85% is observed for 1000 and 4000 cycles, respectively. Encouragingly, 12 F g⁻¹ reversible specific capacitance can still be preserved by the device even after 4000 concurrent charge-discharge cycles at 1 A g⁻¹ current density indicative of outstanding stability of the full cell device. FIG. 7f demonstrates the Ragone plot of the MXNMO//super AC device. The device exhibits the maximum energy density of 37.8 Wh kg⁻¹ and power density of 414.5 W kg⁻¹ at an input current density of 0.25 A g⁻¹. The energy density is 6.72 Wh kg⁻¹ with a higher power density of 4244 W kg⁻¹ at relatively high input current density of 5 A g⁻¹. This device delivers reasonable energy density and power density than other LICs in the reported literatures. The MXene//super AC full-cell device was also tested, which delivered the maximum energy density of 28.93 Wh Kg and power density of 556 W Kg⁻¹ at 0.25 A g⁻¹. The cycling stability of the device was performed at 0.5 A g⁻¹ which shows 71% capacitance retention over 2000 cycles. The detailed electrochemical performance of MXene//super AC is illustrated in FIG. 13. Compared to bare MXene, MXNMO composite exhibits an improved charge storage properties in full cell device. The energy density and cycling stability of full cell MXNMO//super AC is significantly improved as compared to MXene//Super AC device. The comparable power densities could be attributed from the contribution of super AC cathode. Moreover, improvement in energy densities can be attributed to excellent Li⁺ intercalation behaviour of NMO in MXNMO composite even at higher current densities. The porous structure of MXNMO, compared to MXene, improves intercalating redox reactions through a large electrode/electrolyte interface area. Also, MXNMO possesses a robust crystalline framework and short ionic/electronic transport, improving its lithium storage electrochemically. When used as anode for LICs, MXNMO exhibited better Li⁺ ion storage behaviour in terms of cycling stability and high-rate capacities than the MXene. Thus, unbalanced electrochemical kinetics of LIC device has been resolved by the pseudocapacitive MXNMO anode material with super AC as cathode.

Comparative table of reported LICs electrochemical performance with the present work is evaluated in the Tables 1 and 2. The data in tables show that MXNMO//super AC full cell device has far superior power density as compared to Niobium oxide and MXene based asymmetric LICs. The higher power density is attributed to improved intercalation-based charge storage in MXene and MXNMO composite as anode. The material has an excellent ability to intercalate large amount of Li⁺ ions easily at even vey high input current rates with excellent coulombic efficiencies. Other materials of MXene and Niobium-based composite electrodes more often show bulk diffusion or surface adsorption-based storage properties which practically limits their high-rate performance

TABLE 1
Comparative table of the materials with electrochemical performance in half-cell

| | | Electrochemical Performance in half cell | | | |
|---|---|---|---|---|---|
| | | Specific | Current | Cycles | |
| Sr | | capacity | density | in | |
| no. | Materials | (mAh g⁻¹) | (@A g⁻¹) | number | References |
| 1 | Ti₃C₂Tₓ MXene | 110 | 0.2 | ~150 | Chemical |
| | SnO₂ QDs | 108.9 | 0.2 | 150 | Engineering Journal |
| | SnO₂ QDs/ | 790 | 0.2 | ~150 | 2022, 428, 131993 |
| | Ti₃C₂Tₓ-50 | | | | |
| 2 | C—Fe₃O₄ | 570 | 0.2 | 150 | Applied Surface |
| | f-Ti₃C₂ | 290 | 0.2 | 150 | Science 2020, 530, |
| | C—Fe₃O₄/—Ti₃C₂ 1:1 | 1200 | 0.2 | 150 | 147214 |
| 3 | Ti₃C₂Tₓ | 193 | 0.1 | 100 | Present Invention |
| | Nb₂Mo₃O₁₄ | 176 | 0.1 | 100 | |
| | Ti₃C₂Tₓ—Nb₂Mo₃O₁₄ | 205 | 0.1 | 100 | |

TABLE 2
Comparative table of the materials with electrochemical performance in Full-cell

| | Energy | Power | Capacity | |
|---|---|---|---|---|
| Electrode | density | density | retention (%) @ | |
| material | (Wh Kg⁻¹) | (W Kg⁻¹) | (A g⁻¹) | References |
| Nb₁₂O₂₉- | 4.4 | 882 | 80 (500 | Y. Wang et al., Chem. |
| x@C//KAC | | | cycles) @ 0.2 | Soc. Rev. 2016, 45, |
| | | | | 5925-5950. |
| AC//nano- | 13 | 371 | 72 (500 | G. Xu et al., Mater. |
| TiP₂O₇ | | | cycles) @ 0.031 | Today 2017, 20, 191- |
| | | | | 209. |
| AC//LTP | 14 | 180 | 47 (1000 | R. Wang et al., Adv. |
| | | | cycles) @ 0.03 | Funct. Mater. 2015, 25, |
| | | | | 2270-2278 |
| (AC)// | 23 | 800 | 88 (1000 | S. Zhang at al., ACS |
| LiCrTiO₄ | | | cycles) @ 1 | Appl. Mater. Interfaces |
| | | | | 2017, 9, 17136-17144. |
| MXene// | 25 | 1100 | 71 (2000 | Present Invention |
| super AC | | | cycles) @ 0.5 | |
| MXNMO// | 32.5 | 818 | 85 (4000 | |
| super AC | | | cycles) @ 0.5 | |

### Advantages of the Invention

The composite of MXene with NMO can potentially resolve the individual issues of MXenes and NMO by preventing restacking of MXenes due to NMO and containing the volume change in NMO due to buffering by MXenes. The increased surface area of the MXNMO composite could be helpful in accommodating the volume expansion during the charge/discharge process and the reduction in electronic and ionic transmission distances. MXNMO composite has excellent rate performance and cycling stability owing to the open framework structure of NMO and the conducting support of MXenes. MXNMO has a high pseudo-capacitance contribution and the as-designed MXNMO//super AC full cell LIC device delivers excellent electrochemical performance. A high-energy density of 32.51 Wh kg⁻¹ and corresponding power density of 818.32 W kg⁻¹ was observed at 0.5 A g⁻¹ with 85% capacitance retention after 4000 cycles.

We claim:

1. A MXene based composite comprising: MXene material in combination with transition metal oxides, represented by the formula I as: TiₐC_{b}T_{c}-NbₓMo_{y}O_{z};
wherein a is 2-4, b is 1-3, x is 2-3, y is 2-4 and z is 11-17, wherein TiₐC_{b}T_{c} MXene (MX) is present as nanosheets in said composite, and NbₓMo_{y}O_{z} (NMO) is present as nanorods in said composite, wherein the T_{c} is a surface terminated functional group selected from —F, —O, and —OH, and wherein the NMO nanorods form an interfacial contact with the MXene nanosheets in said composite.

2. The MXene based composite as claimed in claim 1, wherein the composite is represented as: Ti₃C₂T_{c}-Nb₂Mo₃O₁₄ wherein Ti₃C₂T_{c} MXene (MX) is present as nanosheets in said composite, and Nb₂Mo₃O₁₄ (NMO) is present as nanorods in said composite, wherein the T_{c} is a surface terminated functional group selected from —F, —O, and —OH.

3. The MXene based composite as claimed in claim 1, wherein the MXene nanosheets are anchored on the surface of NMO nanorods through electrostatic interactions between negatively charged surface-terminated groups like —F, —OH, double bonded oxygen, and the positively charged Nb and Mo ions.

4. The MXene based composite as claimed in claim 1, wherein amount of components present in said composite material is: Ti: 15-20%; C: 22-24%; Nb: 2-2.1%; and Mo: 3-3.1%; and wherein the composite comprises a structure having a Brunauer-Emmett-Teller (BET) surface area in the range of 30 to 40 m² g⁻¹; and wherein the composite comprises a Barrett-Joyner-Halenda Model (BJH) pore size distribution in the range of 2 to 10 nm.

5. A method of synthesizing the MXene based composite as claimed in claim 2, said method comprising:
a. providing phase Ti₃AlC₂ MAX phase;
b. effecting selective extraction of Al from Ti₃AlC₂ MAX phase to obtain the nanosheets of Ti₃C₂Tx MXene;
c. synthesizing Nb₂Mo₃O₁₄ (NMO) from 1:3 mole ratio of the Nb₂O₅ and MoO₃ by a solid-state synthesis method;
d. mixing an aqueous solution of Ti₃C₂Tx MXene and NMO, followed by hydrothermal reaction under sealed conditions to obtain the MXNMO composite;
e. collecting and rinsing the MXNMO composite with water by vacuum filtration; and
f. drying the composite.

6. The method as claimed in claim 5, wherein the ratio of Ti₃C₂Tx MXene and NMO is 2:1 to 1:2; wherein the hydrothermal reaction is effected in an autoclave at 150° C. for 4 h; and wherein the drying is effected at 80° C. for 12 h.

7. The method as claimed in claim 5, wherein the NMO synthesis comprising:
a. Mixing, grinding and drying the Nb₂O₅ and MoO₃ to obtain dried powder;
b. Ball milling the dried powder from step (a) to obtain fine powder;
c. Packing the fine powder in a quartz ampoule;
d. Heating the quartz ampoule containing the fine powder in a Nabertherm muffle furnace, followed by natural cooling to obtain NMO.

8. The method as claimed in claim 7, wherein the mole ratio of Nb₂O₅ and MoO₃ is 1:3 to 3:1; wherein the ball milling is effected at 240 rpm for 8 h; and wherein the heating is effected at 680° C. for 12 h at a 2° C. min⁻¹ heating rate.

9. An electrochemical device comprising the MXene based composite as claimed in claim 1 as a modified anode, wherein the anode material is coated with said composite material.

10. The electrochemical device as claimed in claim 9, wherein the electrochemical device is Lithium-ion capacitors (LICs) selected from full cell device or half-cell device; wherein the LIC full cell device comprises MXNMO anode, supercapacitor grade activated carbon (super AC) as a cathode in anode-to-cathode mass ratio of 1:4 and an organic electrolyte; and wherein the organic electrolyte is LiPF₆ in ethylene carbonate, diethyl carbonate and dimethyl carbonate in the ratio of 1:1:1 v/v/v.

11. The electrochemical device as claimed in claim 9, wherein the MXNMO anode exhibits a discharge capacity of 205 mAh g⁻¹ at 100 mA g⁻¹ after 100 cycles; and wherein the LIC full cell device exhibit specific capacitances of 17, 15, 12, 9.79, 8.2, 7, and 3 F g⁻¹ at current densities of 0.25, 0.5, 1, 1.5, 2, 2.5, and 5 A g⁻¹ respectively.

12. The electrochemical device as claimed in claim 9, wherein the LIC full cell device delivers an energy density of 32.51 Wh kg⁻¹ and a higher power density of 818.32 W kg⁻¹ and 85% capacitance retention over 4000 cycles at 0.5 A g⁻¹; and wherein the LIC full cell device delivers an energy density of 37.8 Wh kg⁻¹ (0.25 A g⁻¹) and a power density of 4244 W kg⁻¹ (5 A g⁻¹) and 85% capacitance retention over 4000 cycles at 0.5 A g⁻¹.

13. The electrochemical device as claimed in claim 9, wherein the LIC full cell device has a cycling stability for around 12000 cycles.
